(19) United States
(12) Patent Application Publication
(10) Pub. No.: US 2012/0044465 A1
(43) Pub. Date: Feb. 23, 2012

(54) LIGHT SOURCE UNIT, ILLUMINATION DEVICE, AND PROJECTION DISPLAY APPARATUS

(76) Inventors: Toshiharu MURAI, Kanagawa (JP); Kazuhiro Fujita, Tokyo (JP); Issei Abe, Kanagawa (JP); Shigeyoshi Misawa, Tokyo (JP)

(21) Appl. No.: 13/204,016

(22) Filed: Aug. 5, 2011

(30) Foreign Application Priority Data
Aug. 19, 2010 (JP) 2010-184173

(51) Int. Cl. G03B 21/14; F21V 9/16

(52) U.S. Cl. 353/85; 362/84

(57) ABSTRACT

A light source unit includes a cylindrical transparent substrate capable of being controlled to rotate; plural segment regions provided at a cylinder portion of a side surface of the cylindrical transparent substrate; layers of different phosphors arranged on at least two of the plural segment regions, the different phosphors being configured to emit light of prescribed wavelength bands upon receiving excitation light; and an excitation light source provided inside or outside of the transparent substrate, the excitation light source being configured to apply the excitation light to the phosphors.

### BACKGROUND OF THE INVENTION

1. Field of the Invention

The present invention relates to a light source unit, an illumination device using the light source unit, and a projection display apparatus such as a projector having the light source unit or the illumination device.

2. Description of the Related Art

In recent years and continuing to the present, large-screen display devices have been coming into widespread use. Therefore, it has been common to conduct conferences, presentations, trainings, etc., using such large-screen display devices.

Known display devices include various types such as liquid crystal display devices and plasma display devices, and are appropriately selected according to location sizes, the number of participants, etc. Among them, projection display apparatuses (hereinafter referred to as “projectors”), which can perform an enlarged display by projecting an image on a projection surface such as a screen, are most popular large-screen display devices because they are relatively inexpensive and excellent in portability (i.e., they are small and light and easily carried).

Under such circumstances, it has been increasingly required to make communication in many occasions and situations. For example, many small conference rooms and meeting spaces separated by partitions, etc., are provided in offices, and conferences or meetings using projectors have been frequently conducted.

Moreover, there has been growing, for example, an urgent demand in the companies that, even if the meeting rooms, etc., are occupied, persons want to use an unoccupied space such as a hallway to conduct a meeting while projecting and displaying information on a wall, etc., of the space.

As such a projector, a conventional mainstream type is one that uses a high-intensity discharge lamp, such as an extra high pressure mercury lamp, as a light source. However, in recent years and continuing to the present, developments have been made so as to use solid light-emitting elements such as red, green, and blue light-emitting diodes (LEDs) and organic EL as light sources, and many proposals for the developments have been made.

For example, a related art described in Patent Document 1 (JP-A-2004-341105) proposes a light source unit composed of phosphor layers that convert ultraviolet light emitted from a solid light source into visible light, a transparent substrate, and the solid light source, and also proposes a projector using the light source unit.

Further, a related art described in Patent Document 2 (JP-A-2009-277516) proposes a light source unit that uses a solid light source for emitting visible light instead of ultraviolet light and is composed of phosphor layers that convert the visible light emitted from the solid light source into visible light having another wavelength, a transparent substrate, and a solid light source, and also proposes a projector using the light source unit.

However, the above related arts give rise to the problem that the thicknesses of the light source units are limited due to structural limitations and thus the light source units cannot be made thinner.

FIGS. 1A and 1B are diagrams showing a configuration example of a projection display apparatus (projector) suffering from the problem in the related arts. FIG. 1A is a schematic diagram as viewed from a direction perpendicular to a plane (hereinafter referred to as a light path surface) including a light path through which light emitted from a light source unit reaches a projection lens group via a display element. FIG. 1B is a schematic diagram as viewed from a direction parallel to the light path surface.

In FIGS. 1A and 1B, an excitation light source 1 outputs excitation light that is applied to phosphor layers formed on a fluorescent wheel described below to cause prescribed color light to be emitted. As the excitation light, blue light having, for example, a wavelength of 450 nm or a wavelength in the vicinity of 450 nm is used.

The fluorescent wheel 3 is composed of a circular (a disc shape, etc.) transparent substrate 5 having the phosphor layers 4 and composed of a motor 6, and configured to be rotatable.

The transparent substrate 5 has plural fan-like segment regions, and the phosphor layers 4 are formed on at least two of the segment regions. Upon receiving the excitation light, each of the phosphor layers 4 emits light (for example, red light or green light) of a prescribed different wavelength band. Further, the phosphor layer is not formed on at least one of the segment regions. Rather, the transparent substrate 5 has a segment region that allows the excitation light to directly pass through. Note that this segment region has a diffusion layer 7 that causes the state of the blue light emitted from the fluorescent wheel 3 to be uniform with those of the other color light.

Thus, when the fluorescent wheel 3 is rotated and the excitation light from the excitation light source 1 is flashed so as to synchronize with boundaries between the segment regions, the color light of red (R), green (G), and blue (B) is emitted from the fluorescent wheel 3 one by one.

Note that in order to increase the light amount of the single color light emitted from one of the phosphor layers 4 and enhance the use efficiency of effective light, an incident mask 2 having an opening formed to correspond to the shape of a light guiding unit 8 described below is arranged between the excitation light source 1 and the fluorescent wheel 3.

The light emitted from the fluorescent wheel 3 is incident on the light guiding unit 8 and converted into a light flux having a uniform strength distribution. Then, the light flux is condensed by a condensing lens group 9, and applied to the display element 11 at a prescribed angle by a reflection mirror 10.

A control unit 12 forms on the display element 11 an image corresponding to a color applied to the display element 11 and modulates the applied light. After being incident on a projection lens group 13, the modulated light is enlarged and projected on a screen, etc., (not shown). Thus, a desired image is displayed.

Like the projector described above, in the case of the configuration in which the circular (a disc shape, etc.) fluorescent wheel 3 is arranged so as to be perpendicular to a light axis in the light source unit, it is evident from FIGS. 1A and 1B that the light source unit cannot be made thinner due to limitations on the diameter of the fluorescent wheel 3 even if the respective components and units arranged along the light axis are reduced in size.
Patent Document 1: JP-A-2004-341105
Patent Document 2: JP-A-2009-277516

### SUMMARY OF THE INVENTION

The present invention has been made in order to solve the above problem in the related arts and may provide:

(1) a light source unit capable of being made thinner than conventional light source units;

(2) the light source unit capable of providing rigidity in a transparent substrate or accomplishing the weight reduction and cost reduction of the transparent substrate in addition to the accomplishment of the above object (1);

(3) the light source unit capable of increasing an emitted light amount in addition to the accomplishment of the above object (1) or (2);

(4) the light source unit capable of enhancing the use efficiency of excitation light in addition to the accomplishment of any of the above objects (1) through (3);

(5) the light source unit having a specific unit capable of generating light of a wavelength band different from that of the excitation light and capable of being used as a single color light source in addition to the accomplishment of any of the above objects (1) through (4);

(6) the light source unit capable of causing, when the excitation light is caused to directly pass through as single color light, the excitation light to be uniform with other color light in addition to the accomplishment of any of the above objects (1) through (5);

(7) the light source unit capable of accomplishing electric power saving in addition to the accomplishment of any of the above objects (1) through (6);

(8) the light source unit capable of increasing brightness and enhancing color reproducibility in addition to the accomplishment of any of the above objects (1) through (7);

(9) the light source unit having a specific unit that increases brightness and enhances color reproducibility in addition to the accomplishment of any of the above objects (1) through (8);

(10) the light source unit capable of further increasing an emitted light amount in addition to the accomplishment of any of the above objects (1) through (9);

(11) the light source unit capable of increasing the use efficiency of emitted light in addition to the accomplishment of the above object

(10);

(12) the light source unit having another unit that further increases the emitted light amount in addition to the accomplishment of any of the above objects (1) through (9);

(13) a thin illumination device using the light source unit that may accomplish any of the above objects (1) through (12); and

(14) a thin projection display apparatus (projector, etc.) using the light source unit that may accomplish any of the above objects (1) through (12) or the illumination device that may accomplish the above object (13).

In order to accomplish the above objects, an embodiment of the present invention provides a light source unit including a cylindrical transparent substrate capable of being controlled to rotate; plural segment regions provided at a cylinder portion of a side surface of the cylindrical transparent substrate; layers of different phosphors arranged on at least two of the plural segment regions, the different phosphors being configured to emit light of prescribed wavelength bands upon receiving excitation light; and an excitation light source provided inside or outside of the transparent substrate, the excitation light source being configured to apply the excitation light to the phosphors.

Other objects, features and advantages of the present invention will become more apparent from the following detailed description when read in conjunction with the accompanying drawings.

### BRIEF DESCRIPTION OF THE DRAWINGS

FIGS. 1A and 1B are diagrams schematically showing a configuration example of a projection display apparatus based on related arts;

FIGS. 2A and 2B are diagrams schematically showing an embodiment of a projection display apparatus based on the present invention;

FIG. 3 is a diagram schematically showing another embodiment of a light source unit according to the present invention;

FIG. 4 is a diagram schematically showing a state in which a fluorescent cylinder and an assisting cylinder of the light source unit shown in FIG. 3 are exploded; and

FIG. 5 is a diagram schematically showing still another embodiment of the light source unit according to the present invention.

### DETAILED DESCRIPTION OF THE PREFERRED EMBODIMENTS

Hereinafter, a description is given in detail of embodiments for carrying out the present invention with reference to the accompanying drawings.

### EMBODIMENTS

### First Embodiment

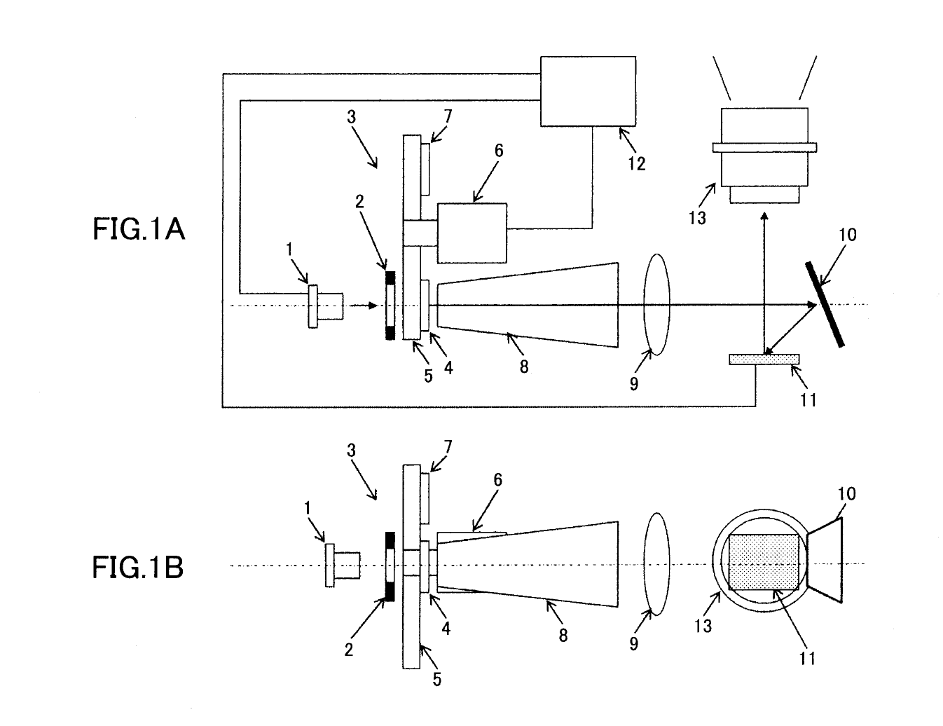

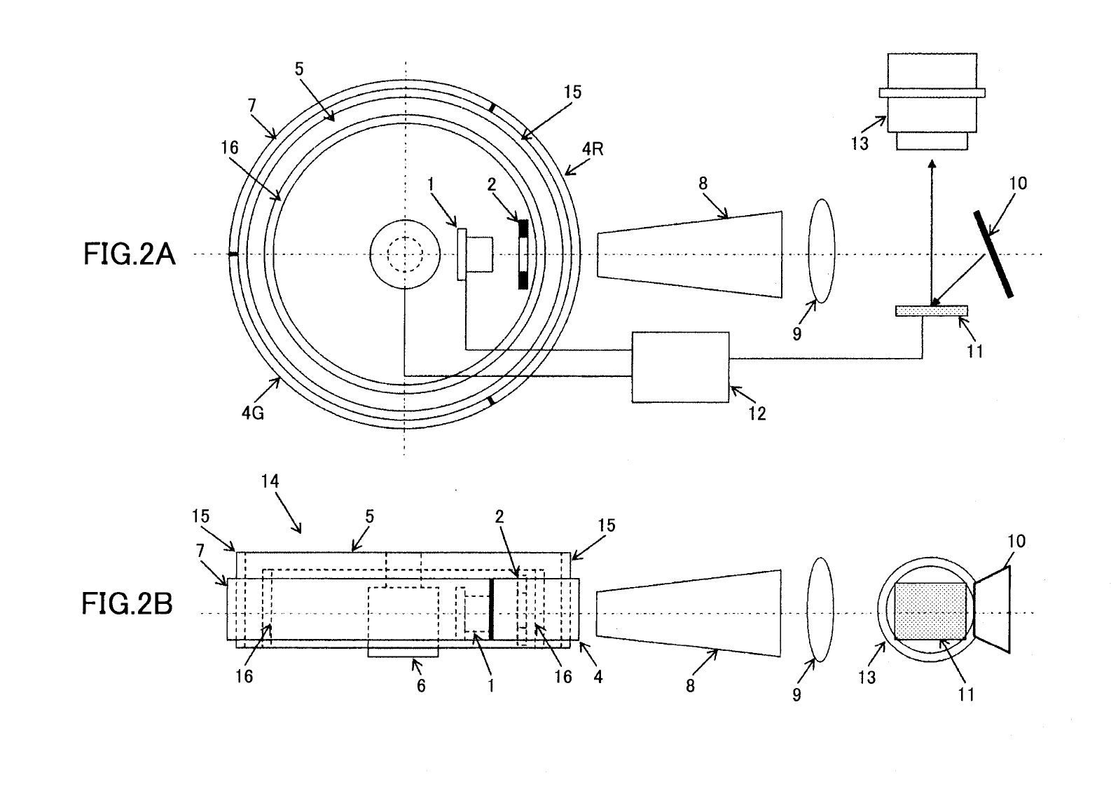

FIGS. 2A and 2B schematically show an embodiment of a projection display apparatus (projector) based on the present invention in such a manner as to correspond to the related art shown in FIGS. 1A and 1B. As in the case of FIGS. 1A and 1B, FIG. 2A is a schematic diagram as viewed from a direction perpendicular to a plane (light path surface) including a light path through which light emitted from a light source unit reaches a projection lens group via a display element. FIG. 1B is a schematic diagram as viewed from a direction parallel to the light path surface. Note that in FIGS. 2A and 2B, components or units having the same functions as those of the projection display apparatus shown in FIGS. 1A and 1B are denoted by the same numerals.

The configuration of the projection display apparatus shown in FIGS. 2A and 2B is different from that of the projection display apparatus shown in FIGS. 1A and 1B in that the light source unit has a cylindrical fluorescent member (hereinafter referred to as a fluorescent cylinder) 14 instead of a fluorescent wheel 3.

That is, in the configuration shown in FIGS. 2A and 2B, the fluorescent cylinder 14 is provided as the light source unit. The fluorescent cylinder 14 has plural segment regions at the cylinder portion of the side surface of a cylindrical transparent substrate 5 capable of being controlled to rotate. On at least two of the segment regions are arranged layers of different phosphors (hereinafter referred to as phosphor layers) 4 that emit light of a prescribed wavelength band upon receiving excitation light. An excitation light source 1 that applies the excitation light to the phosphors is provided inside (or outside) of the transparent substrate 5.

More specifically, the fluorescent cylinder 14 has the cylindrical (for example, a cylindrical shape like a laboratory dish) transparent substrate 5, has the phosphor layers 4, etc., at the cylinder portion of its side surface, and has the rotor of a motor 6 at the center of its circular bottom surface so as to be rotatable. As the transparent substrate 5, a glass substrate, a transparent resin substrate, etc., are preferably used.

The cylinder portion of the side surface of the transparent substrate 5 has the plural segment regions divided in a circumferential direction by boundary lines along the length direction of the cylinder. The phosphor layers 4 are formed on at least two of the segment regions.

Further, inside of the transparent substrate 5, the excitation light source 1 that applies the excitation light to the phosphors is arranged. As the excitation light source 1, a light-emitting diode (LED) or a laser light emitter (semiconductor laser (LD), etc.) is, for example, used.

Note that the shape of the transparent substrate 5 is not limited to the cylindrical shape described above, but the transparent substrate 5 may have a polygonal cylindrical shape such as a hexagon, an octagon, and a dodecagon.

Further, the light source unit may also be configured such that the excitation light source 1 is arranged outside of the transparent substrate 5. With this configuration, the excitation light source 1 can apply the excitation light to the phosphor layers 4 from the outside of the transparent substrate 5 so as to make use of reflection light from the phosphor layers 4.

When the excitation light is applied from the excitation light source 1, each of the phosphor layers 4 emits light (for example, red light or green light) of a prescribed different wavelength band. As the excitation light, blue light having, for example, a wavelength of 450 nm or a wavelength in the vicinity of 450 nm is preferably used. Consequently, the excitation light can be directly used as image light. In this case, the phosphor layer is not formed on at least one of the segment regions. In other words, the transparent substrate 5 has the segment region that allows the excitation light to directly pass through. Note that this segment region has a diffusion layer 7 that causes the state of the blue light emitted from the fluorescent cylinder 14 to be uniform with those of the other color light.

A non-reflection coating layer 16 is preferably formed on the inner side surface of the cylinder portion of the transparent substrate 5. Thus, the excitation light passes through the non-reflection coating layer 16 without being hardly reflected to the side of the light source 1, is incident on the transparent substrate 5, and is efficiently applied to the phosphor layers 4 or the diffusion layer 7.

Moreover, a dichroic layer 15 is preferably formed on the outer side surface of the cylinder portion of the transparent substrate 5 (at the inside of the phosphor layers 4 and diffusion layer 7). Thus, among the light emitted in all directions from the phosphor layers 4 or the diffusion layer 7, the light emitted to the transparent substrate 5 is reflected. Consequently, the amount of the light emitted from the fluorescent cylinder 14 can be increased.

With the configuration described above, when the fluorescent cylinder 14 is rotated by the motor 16 and the excitation light from the excitation light source 1 is flashed so as to synchronize with boundaries between the segment regions, the color light of red (R), green (G), and blue (B) is emitted from the fluorescent cylinder 14 one by one.

Note that in order to increase the light amount of the single color light emitted from one of the phosphor layers 4 and enhance the use efficiency of effective light, an incident mask 2 having an opening formed to correspond to the shape of a light guiding unit 8 is arranged between the excitation light source 1 and the fluorescent cylinder 14.

The color light of red (R), green (G), and blue (B) emitted from the fluorescent cylinder 14 is incident on the light guiding unit 8 serving as a light-source-side optical system and converted into a light flux having a uniform strength distribution. Then, the light flux is condensed by a condensing lens group 9, and applied to a display element 11 at a prescribed angle by a reflection mirror 10.

Here, the light source unit using the fluorescent cylinder 14, the light guiding unit 8, and the condensing lens group 9 constitute the illumination device of the projection display apparatus (projector).

A control unit 12 serving as a display control unit, which controls the light source unit (such as the motor 6 that rotates the fluorescent cylinder 14 and the excitation light source 1) of the illumination device described above and which controls the display element 11, forms on the display element 11 an image corresponding to a color applied from the illumination device to the display element 11 and modulates the applied light. After being incident on a projection lens group 13 serving as a projection-side optical system, the modulated light is enlarged and projected on a screen that is a surface to be projected, etc., (not shown). Thus, a desired image is displayed.

In FIGS. 2A and 2B, the segment regions are set such that the color light red (R), green (G), and blue (B), so-called the light of three primary colors, is emitted one by one. However, a segment region may be added in which the phosphor layer 4 emits light of a wavelength band of a complementary color such as yellow.

As described above, when the phosphor layer 4 that emits the light of the wavelength band of the complementary color is arranged for each of the segment regions in addition to the phosphor layers 4 that emit the light of the wavelength bands of the primary colors, the brightness of the light source unit can be increased and color reproducibility can be enhanced.

### Second Embodiment

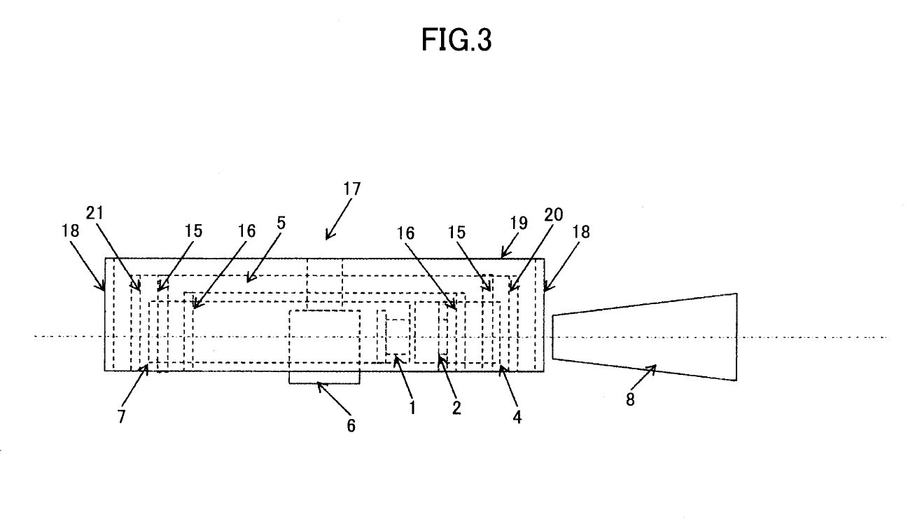

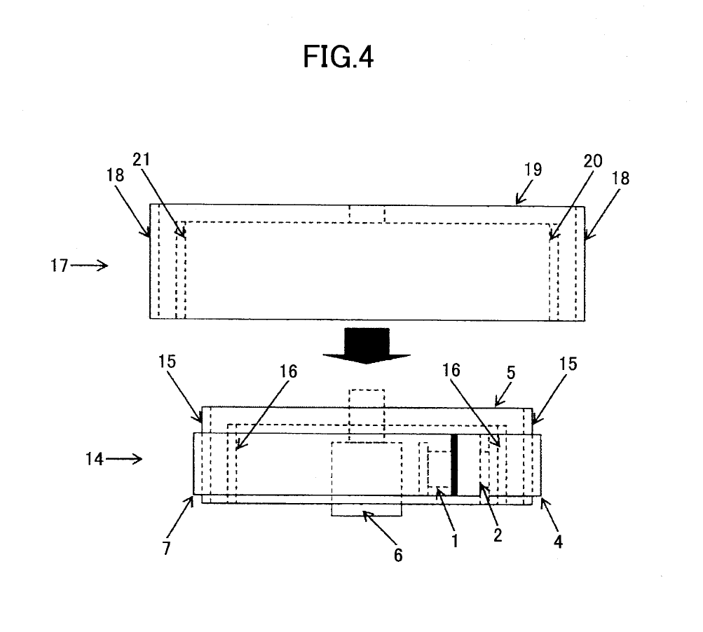

FIG. 3 schematically shows another embodiment of the light source unit according to the present invention. FIG. 4 schematically shows a state in which the fluorescent cylinder and the assisting cylinder of the light source unit shown in FIG. 3 are exploded.

In this embodiment, as shown in FIGS. 3 and 4, the tubular (for example, cylindrical) assisting cylinder 17 is attached to the rotor of the motor 6 so as to cover the transparent substrate 5 of the fluorescent cylinder 14 shown in FIGS. 2A and 2B, and configured to be integrally rotatable with the fluorescent cylinder 14.

In the assisting cylinder 17, the inner side surface of the cylinder portion of an assisting transparent substrate 19 is divided into plural segment regions. Among the segment regions, a prescribed segment region has an excitation light reflection layer 20 that causes light of a wavelength band other than the excitation light, such as the light of the wavelength band emitted from the phosphor layers 4, to pass through. The position of the prescribed segment region corresponds to those of the segment regions in which the phosphor layers 4 of the fluorescent cylinder 14 are formed.

Further, the other segment region has an excitation light passing layer 21 that causes only the light of the wavelength band of the excitation light to pass through. The position of the other segment region corresponds to that of the segment region in which the phosphor layers of the fluorescent cylinder 14 are not formed.

On the other hand, a non-reflection coating layer 16 is formed on the entirety of the outer side surface of the cylinder portion of the assisting transparent substrate 19.

In other words, all of the excitation light incident on the phosphor layers 4 are not absorbed in the phosphor layers 4, but some of it may pass through the phosphor layers 4. In this case, if the light source unit is provided with the assisting cylinder 17, the excitation light passing through the phosphor layers 4 is reflected to the side of the transparent substrate 5 to be incident on the phosphor layers 4 again, whereby the generation of the light of a prescribed band can be increased.

As described above, according to this embodiment, the assisting transparent substrate 19 formed to correspond to the shape of the transparent substrate 5 and having the segment regions, etc., are arranged on the side opposite to the excitation light source 1 of the transparent substrate 5, and the excitation light passing through the phosphor layers 4 are reflected to the side of the transparent substrate 5 to be absorbed in the phosphor layers 4. Therefore, the amount of the light emitted from the light source unit can be further increased.

Further, the non-reflection coating layer 18 is formed on the surface of the assisting transparent substrate 19 on the side opposite to the transparent substrate 5. Therefore, the use efficiency of the emitted light can be further enhanced, and the light source unit accomplishing high brightness and electric energy saving can be provided.

### Third Embodiment

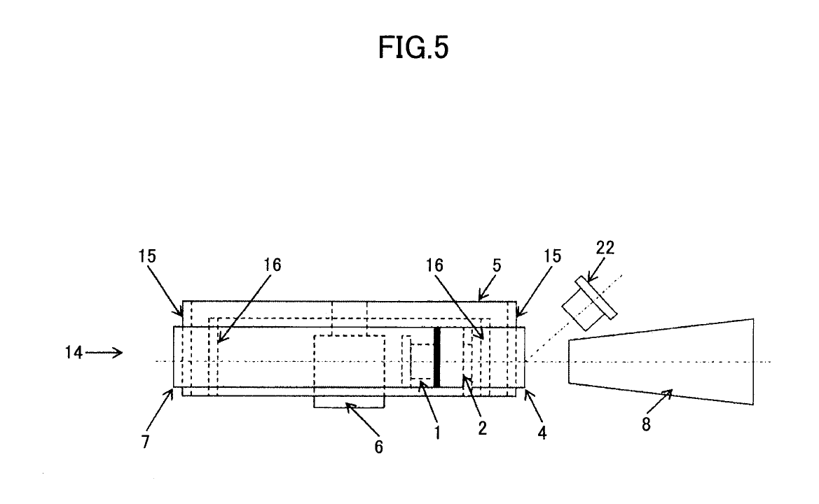

FIG. 5 schematically shows still another embodiment of the light source unit according to the present invention.

In this embodiment, an assisting excitation light source 22 is arranged on the side of the surface of the transparent substrate 5 where the phosphor layers 4 of the transparent substrate 5 are formed (on the side of the outer peripheral surface of the transparent substrate 5).

The assisting excitation light source 22 is arranged at a position away by a given distance from the light axis of the excitation light source 1 at a prescribed angle such that the excitation light emitted from the assisting excitation light source 22 is applied to the phosphor layers 4 of the transparent substrate 5 and the light emitted from the fluorescent cylinder 14 and incident on the light guiding unit 8 is not intercepted.

Thus, the excitation light can be applied from the assisting excitation light source 22 to the phosphor layers 4 having a low light emitting efficiency, and the amount of the light emitted from the phosphor layers 4 can be increased.

As described above, according to this embodiment, the assisting excitation light source 22 is arranged on the side opposite to the excitation light source 1 via the transparent substrate 5. Therefore, with the application of the excitation light from the assisting excitation light source 22 to the phosphor layers 4 having a low light emitting efficiency, the amount of the light emitted from the phosphor layers 4 can be increased and high brightness of the light source unit can be accomplished.

The present invention is not limited to the specifically disclosed embodiments, and variations and modifications may be made without departing from the scope of the present invention.

The present application is based on Japanese Priority Application No. 2010-184173 filed on Aug. 19, 2010, the entire contents of which are hereby incorporated herein by reference.

What is claimed is:

1. A light source unit comprising:
a cylindrical transparent substrate capable of being controlled to rotate;
plural segment regions provided at a cylinder portion of a side surface of the cylindrical transparent substrate;
layers of different phosphors arranged on at least two of the plural segment regions, the different phosphors being configured to emit light of prescribed wavelength bands upon receiving excitation light; and
an excitation light source provided inside or outside of the transparent substrate, the excitation light source being configured to apply the excitation light to the phosphors.

2. The light source unit according to claim 1, wherein
the transparent substrate is a glass substrate or a transparent resin substrate.

3. The light source unit according to claim 1, further comprising:
a dichroic layer formed on a surface of the transparent substrate on a side where the layers of the different phosphors are arranged, the dichroic layer being configured to allow the excitation light to pass through and reflect light of other wavelength bands.

4. The light source unit according to claim 1, further comprising:
a non-reflection coating layer formed on a surface of the transparent substrate on a side opposite to the side where the layers of the different phosphors are arranged.

5. The light source unit according to claim 1, wherein
the excitation light source is configured to apply light of a wavelength band having a shorter wavelength than the light of the prescribed wavelength bands emitted by the different phosphors.

6. The light source unit according to claim 1, further comprising:
a diffusion layer formed on the segment region of the transparent substrate where the layers of the different phosphors are not arranged, the diffusion layer being configured to produce a diffusion effect.

7. The light source unit according to claim 1, wherein
the excitation light source is a light-emitting diode or a laser light emitter configured to apply light of a wavelength band of a color of blue.

8. The light source unit according to claim 1, wherein
each of the different phosphors emits, upon receiving the excitation light, light of a wavelength bands of a primary color and a complementary color.

9. The light source unit according to claim 1, wherein
the plural segment regions of the transparent substrate include
a segment region on which is arranged the layer of the phosphor configured to emit light of a wavelength band of a color of red,
a segment region on which is arranged the layer of the phosphor configured to emit light of a wavelength band of a color of green, and
a segment region on which is arranged the layer of the phosphor configured to emit light of a wavelength band of a color of yellow.

10. The light source unit according to claim 1, further comprising:
an assisting transparent substrate capable of being controlled to rotate, the assisting transparent substrate being coaxial with the transparent substrate and synchronized with the transparent substrate; wherein
the assisting transparent substrate has an excitation light reflection layer so as to correspond to each of the plural segment regions of the transparent substrate, the excitation light reflection layer being configured to reflect the excitation light to a surface thereof on a side of the transparent substrate and allow the light of the wavelength bands emitted by the different phosphors to pass through.

11. The light source unit according to claim 10, further comprising:
a non-reflection coating layer formed on a surface of the assisting transparent substrate on a side opposite to the side of the transparent substrate.

12. The light source unit according to claim 1, further comprising:
an assisting excitation light source besides the excitation light source; wherein
the transparent substrate having the plural segment regions is arranged between the excitation light source and the assisting excitation light source.

13. An illumination device comprising:
the light source unit according to claim 1;
a light guiding unit; and
a condensing lens group.

14. A projection display apparatus comprising:
a light source unit;
a display element;
a light-source-side optical system configured to guide light from the light source unit to the display element;
a projection-side optical system configured to project an image projected from the display element on a surface to be projected; and
a display control unit configured to control the light source unit and the display element;
wherein
the light source unit is the light source unit according to claim 1.

15. A projection display apparatus comprising:
the illumination device according to claim 13;
a display element;
an optical system configured to apply light from the illumination device to the display element;
a projection-side optical system configured to project an image projected from the display element on a surface to be projected; and
a display control unit configured to control the light source unit of the illumination device and the display element.
